(19) United States
(12) Patent Application Publication
(10) Pub. No.: US 2013/0015742 A1
(43) Pub. Date: Jan. 17, 2013

(54) SYNCHRONOUS MOTOR

(71) Applicants: Yoshimitsu Inoue, Niwa-gun (JP); Akiyoshi Satake, Niwa-Gun (JP)

(72) Inventors: Yoshimitsu Inoue, Niwa-gun (JP); Akiyoshi Satake, Niwa-Gun (JP)

(73) Assignee: OKUMA CORPORATION, Aichi (JP)

(21) Appl. No.: 13/547,815

(22) Filed: Jul. 12, 2012

(30) Foreign Application Priority Data
Jul. 13, 2011 (JP) 2011-154455

(51) Int. Cl. H02K 3/28

(52) U.S. Cl. 310/208

(57) ABSTRACT

A synchronous motor 100 includes a rotor 20 having a permanent magnet 26 on the surface of or inside the rotor, a stator 10 made of a soft magnetic material and having tooth members T1 to T18 and slots S1 to S18, and element coils 11, 12 wound around each of the tooth members T1 to T18 as concentrated windings and arranged in multiple layers along the extending direction of the tooth members T1 to T18. The element coils 11, 12 are provided three coils each for each phase in a circumferential direction to form rotating direction windings 101 to 206 for each phase. For each phase, the rotating direction windings 101 to 206 are displaced from each other by one slot in the rotating direction between adjacent layers. As a result, torque ripples are reduced in motors using concentrated windings.

### CROSS-REFERENCE TO RELATED APPLICATION(S)

This application claims priority to Japanese Patent Application No. 2011-154455, filed on Jul. 13, 2011, which is incorporated herein by reference in its entirety.

### BACKGROUND OF THE INVENTION

(1) Field of the Invention

The present invention relates to a synchronous motor used in servomechanisms of machine tools or the like, and particularly to the number of slots of a stator and a winding structure thereof, as well as the number of magnetic poles of a rotor and a winding method thereof, in order to realize torque ripple minimization and a wider operating frequency range of a synchronous motor which generates high torque, especially during low speed operation.

(2) Description of Related Art

FIG. 9 shows a sectional view of a main parts of a synchronous motor 900 using conventional concentrated windings. The synchronous motor 900 includes a stator 90 and a rotor 93. The stator 90 includes a plurality of slots S1-S18 and a plurality of tooth members T1-T18, with element coils 91 wound around individual tooth members T1-T18. Several element coils 91 are arranged continuously in a rotating direction for U, V, and W phases, respectively. In the example shown in FIG. 9, three element coils 91 are arranged continuously in a circumferential direction for each phase to form a plurality of windings arranged in the rotating direction (hereinafter referred to as rotating direction windings) 901-906. Therefore, in the example shown in FIG. 9, two coils each of the U, V, and W phases, which are concentrated windings, are disposed circumferentially. On the other hand, the rotor 93 includes a magnetic substance 94 fitted into a ring 95, and a permanent magnet 96 attached thereto. In this type of synchronous motor 900, the element coils 91 are arranged continuously in the circumferential direction to form a rotating direction winding 901 as shown in FIG. 10A, which makes a trapezoidal shaped distribution of the magnetic flux in the circumferential direction, as shown in FIG. 10B, when the electric current is caused to flow through the rotating direction winding 901. As a result, torque ripples are easily generated.

To avoid this, many efforts have been made in manufacturing the stator or making windings. For example, it has been proposed that a tooth member of the stator have a cylindrical face opposite to the rotor so that a distance between the end face of the tooth member and the surface of the rotor is shorter at the center part of the tooth member, and the distance is longer at both ends of the tooth member, thereby reducing cogging torque (e.g., see JP2-30270U). Manufacturing methods of the stator have often been devised by using a so-called skew structure, which causes changes of the rotating direction, in the stator core stack or the magnetic pole structure of the rotor (e.g., see JP11-308795A). However, this may cause reduction of a torque constant, and may also become a factor affecting cost increase, because special tools such as jigs are necessary during manufacturing to provide the skew structure. Also, the performance and productivity of inserting windings into the slots may be deteriorated. The winding method has also been devised generally by the number of slots is indivisible by the number of poles, or adopting distributed windings instead of concentrated windings (e.g., see JP5-161325A). This leads to an increase of coils and the number of process steps of winding coils.

### BRIEF SUMMARY OF THE INVENTION

As described above, motors using concentrated windings generally have a problem of high torque ripples. When the skew structure is used in the stator slots or the rotor magnetic poles to reduce the torque ripples, a torque constant is decreased.

An object of the present invention is to provide a simple method to reduce torque ripples of a concentrated winding motor.

A synchronous motor according to the present invention includes a rotor having a permanent magnet on the surface of or inside the rotor, a stator made of a soft magnetic material and having a plurality of tooth members and a plurality of slots, and a plurality of element coils wound around each of the tooth member as concentrated windings and arranged in multiple layers in an extending direction of the tooth members. A predetermined number of the element coils are arranged continuously for each phase in a circumferential direction to form a winding of a rotating direction for each phase. The rotating direction windings for each phase are displaced from each other between adjacent layers by one slot in the rotating direction.

In the synchronous motor according to the present invention, if it is assumed that N_{cont} represents the number of the element coils provided continuously for each phase in a circumferential direction, Nₛₗₒₜ represents the number of the slots, Nₚₒₗₑ represents the number of poles of the rotor, and Nₚₕₐₛₑ represents the number of applied phases of electric current, then Nₛₗₒₜ±Nₚₒₗₑ=2n (n=1, 2, . . . integer), and Nₛₗₒₜ=A/(A−1)·Nₚₒₗₑ (note that A=Nₚₕₐₛₑ·N_{cont}) are satisfied. Preferably, the element coils provided continuously for N_{cont} times are wound in m layers (m>1 and an integer) and displaced from each other between adjacent layers by one slot in the rotating direction.

In the synchronous motor according to the present invention, when the number of the element coils provided continuously is N_{cont}, and the number of layers, m, of the element coils is m=2k (k is a natural number), the element coils are wound around [N_{cont}−(2k−1)] tooth members as concentrated windings, in the center part of the rotating direction winding for one phase, and wound around (2k−1) tooth members externally from the center of the rotating direction windings, such that the number of the element coils is larger as they become closer to the center of the rotating direction winding, and is smaller as they become farther from the center of the rotating direction winding. When m=2k−1 (k is a natural number), the element coils are wound around [N_{cont}−2(k−1)] tooth members as concentrated windings, in the center part of the rotating direction winding for one phase, and wound around 2(k−1) tooth members externally from the center of the rotating direction windings, such that the number of the element coils is larger as they become closer to the center of the rotating direction winding, and is smaller as they become farther from the center of the rotating direction winding.

In the synchronous motor according to the present invention, multiple sets of windings having an identical electrical characteristic are provided. Preferably, the multiple sets of windings are switched by winding switching means an external controller so that the sets of windings are serially connected during low speed operation, and the sets of windings are connected in parallel during high speed operation. It is also preferable that the winding directions of the windings around adjacent tooth members are opposite to each other.

The present invention is advantageous in that the torque ripples can be reduced by a simple method in the motor using concentrated windings.

Other features, elements, characteristics, and advantages of the present invention will become more apparent from the following description of preferred embodiments of the present invention with reference to the attached drawings.

### BRIEF DESCRIPTION OF THE SEVERAL VIEWS OF THE DRAWING

FIG. 1 is a sectional view of a synchronous motor according to an embodiment of the present invention;

FIG. 2 is an explanatory view showing layers and sets of windings of the synchronous motor according to the embodiment of the present invention;

FIG. 3 is an explanatory view showing the windings of the synchronous motor according to the embodiment of the present invention;

FIG. 4A is an explanatory view showing rotating direction winding and magnetic flux caused by the electric current in the synchronous motor according to the embodiment of the present invention;

FIG. 4B is an explanatory view showing distribution of the magnetic flux of the rotating direction winding shown in the FIG. 4A;

FIG. 5 is an explanatory view showing a winding method in a synchronous motor according to another embodiment of the present invention;

FIG. 6 shows a winding method in a synchronous motor according to another embodiment of the present invention;

FIG. 7 is an explanatory view showing layers and sets of windings of the synchronous motor according to another embodiment of the present invention;

FIG. 8 is an explanatory view showing the windings of the synchronous motor according to another embodiment of the present invention;

FIG. 9 is a sectional view of a synchronous motor of a conventional art; and

FIG. 10A is an explanatory view showing rotating direction winding and magnetic flux caused by the electric current of the synchronous motor of the conventional art.

FIG. 10B is an explanatory view showing distribution of the magnetic flux of the rotating direction winding shown in the FIG. 10A;

### DESCRIPTION OF THE PREFERRED EMBODIMENTS

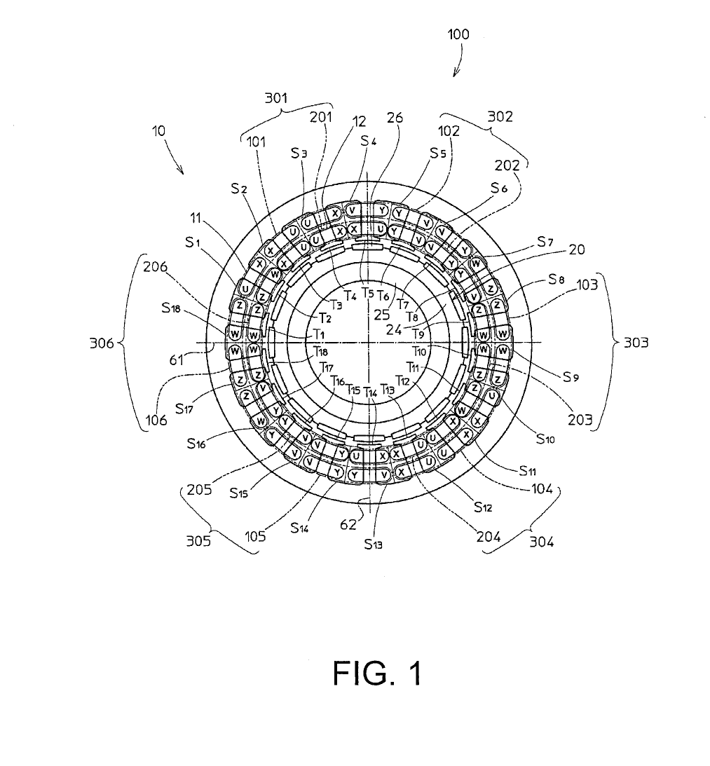

In the following, an embodiment of the present invention will be described with reference to the drawings. As shown in FIG. 1, a synchronous motor according to this embodiment includes a stator 10 and a rotor 20. The stator 10 includes a plurality of (18) slots S1-S18 and a plurality of (18) tooth members T1-T18, with lower layer element coils 11 and upper layer element coils 12 wound around each tooth member T1-T18. The rotor 20 includes a magnetic substance 24 fitted into a ring 25 and a permanent magnet 26 fixed thereto. Sixteen permanent magnets 26 are attached in a circumferential direction, so that the number of poles of the rotor 20 is 16. Note that reference numbers 61, 62 indicate horizontal and vertical center lines, respectively.

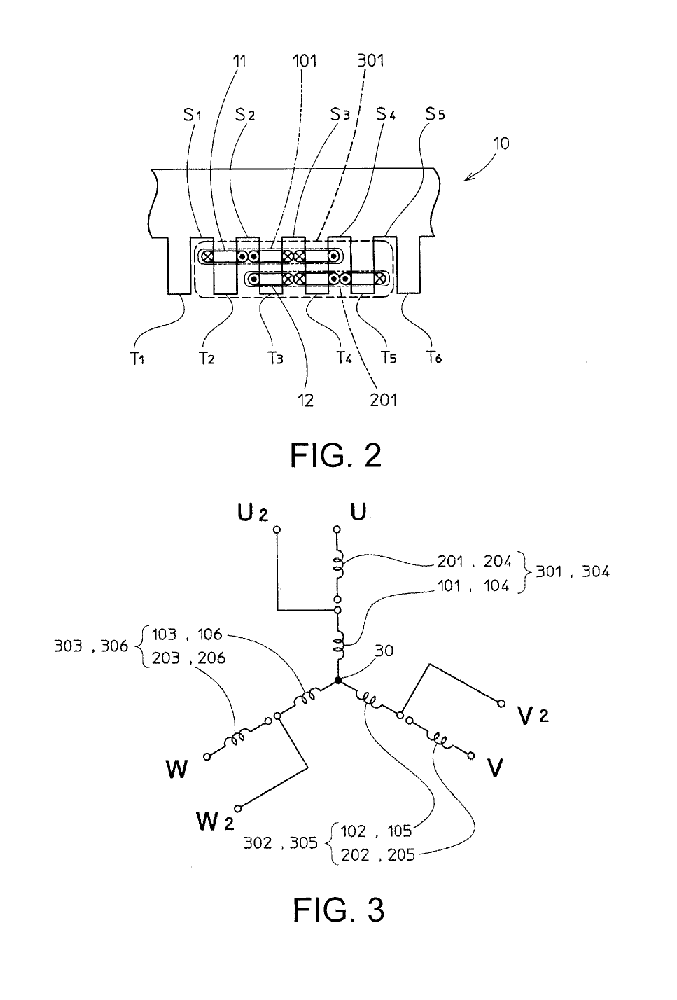

A U-phase lower layer element coil 11 is wound around a second tooth member T2 between first and second slots S1, S2. In FIG. 1, reference characters U indicate input terminals of the U-phase windings, and reference characters X indicate output terminals of the U-phase windings. Therefore, the lower layer element coil 11 wound around the second tooth member T2 runs into the stator 10 from the slot S1, is wound toward the second slot S2, and goes out of the stator 10 from the second slot S2 as shown in FIG. 2. Note that in FIG. 2, x marks in circles indicate that the winding runs through the drawing from the front side to the back side of the paper, and dots in circles indicate that the winding runs through the drawing from the back side to the front side of the paper. Also note that FIG. 2 is a schematic view of slots and tooth members arranged on the inner surface of the stator 10 in the circumferential direction when shown in a linearly extended manner. As shown in FIG. 1, the lower layer element coil 11 wound around the third tooth member T3 between second and third slots S2, S3 runs into the stator 10 from the third slot S3 marked with the reference character U, is wound toward the second slot S2, and goes out of the stator 10 from the second slot S2 marked with the reference character x. Namely, the winding directions of the lower layer element coil 11 wound around the second tooth member T2 and the lower layer element coil 11 wound around the third tooth member T3 are opposite to each other. Similarly, the lower layer element coil 11 wound around the fourth tooth member T4 between third and fourth slots S3, S4 runs into the stator 10 from the third slot S3 marked with the reference character U, is wound toward the fourth slot S4, and goes out of the stator 10 from the fourth slot S4 marked with the reference character x, such that the winding directions of the lower layer element coil 11 and the lower layer element coil 11 wound around the tooth member T3 are opposite to each other. As such, adjacent lower layer element coils 11 run in opposite directions.

In the same context, a V-phase lower layer element coil 11 is wound around the fifth, sixth, and seventh tooth members T5, T6, T7, and a W-phase lower layer element coil 11 is wound around the eighth, ninth, and tenth tooth members T8, T9, T10, such that adjacent lower element coils 11 are wound in the opposite directions. Note that in FIG. 1, reference characters V, W indicate input terminals of V- and W-phase windings, and reference characters Y, Z indicate output terminals of the V- and W-phase windings. In addition, another U-phase lower layer element coil 11 is wound around the eleventh, twelfth, and thirteenth tooth members T11, T12, T13, another V-phase lower layer element coil 11 is wound around the fourteenth, fifteenth, and sixteenth tooth members T14, T15, T16, and another W-phase lower layer element coil 11 is wound around the seventeenth, eighteenth, and first tooth members T17, T18, T1.

On the other hand, a U-phase upper layer element coil 12 is displaced from the U-phase lower layer element coil 11 by 1 slot or 1 tooth member in a circumferential direction, and is wound around the third tooth member T3 between the second and third slots S2, S3, and also wound around the fourth and fifth tooth members T4, T5. In addition, the upper layer element coils 12 are arranged on the near center side of the lower layer element coils 11 of the stator 10. Similar to the lower layer element coils 11, adjacent upper layer element coils 12 are wound in opposite directions.

Similarly, the V-phase upper layer element winding 12 is wound around the sixth, seventh, and eighth tooth members T6, T7, T8, the W-phase upper layer element winding 12 is wound around the ninth, tenth, and eleventh tooth members T9, T10, T11, another U-phase upper layer element coil 12 is wound around the twelfth, thirteenth, and fourteenth tooth members T12, T13, T14, another V-phase upper layer element winding 12 is wound around the fifteenth, sixteenth, and seventeenth tooth members T15, T16, T17, and another W-phase upper layer element coil 12 is wound around the eighteenth, first, and second tooth members T18, T1, T2.

A U-phase lower layer rotating direction winding 101 is formed by three U-phase lower layer element coils 11 wound around three consecutive tooth members from the second to the fourth tooth members, T2, T3, T4. A V-phase lower layer rotating direction winding 102 is formed by three V-phase lower layer element coils 11 wound around three consecutive tooth members from the fifth to the seventh tooth members, T5, T6, T7. A W-phase lower layer rotating direction winding 103 is formed by three W-phase lower layer element coils 11 wound around three consecutive tooth members from the eighth to the tenth tooth members, T8, T9, T10. Another U-phase lower layer rotating direction winding 104 is formed by three U-phase lower layer element coils 11 wound around three consecutive tooth members from the eleventh to the thirteenth tooth members, T11, T12, T13. Another lower layer V-phase rotating direction winding 105 is formed by three V-phase lower layer element coils 11 wound around three consecutive tooth members from the fourteenth to the sixteenth tooth members, T14, T15, T16. Another lower layer W-phase rotating direction winding 106 is formed by three W-phase lower layer element coils 11 wound around three consecutive tooth members of the seventeenth, the eighteenth, and the first tooth members, T17, T18, T1.

Similarly, a U-phase upper layer rotating direction winding 201 is formed by three U-phase upper layer element coils 12 wound around three consecutive tooth members from the third to the fifth tooth members, T3, T4, T5. A V-phase upper layer rotating direction winding 202 is formed by three V-phase upper layer element coils 12 wound around three consecutive tooth members from the sixth to the eighth tooth members, T6, T7, T8. A W-phase upper layer rotating direction winding 203 is formed by three W-phase upper layer element coils 12 wound around three consecutive tooth members from the ninth to the eleventh tooth members, T9, T10, T11. Another U-phase upper layer rotating direction winding 204 is formed by three U-phase upper layer element coils 11 wound around three consecutive tooth members from the twelfth the fourteenth tooth members, T12, T13, T14. Another upper layer V-phase rotating direction winding 205 is formed by three V-phase upper layer element coils 12 wound around three consecutive tooth members from the fifteenth to the seventeenth tooth members, T15, T16, T17. Another upper layer W-phase rotating direction winding 206 is formed by three W-phase upper layer element coils 12 wound around three consecutive tooth members of the eighteenth, the first, and the second tooth members, T18, T1, T2.

As described above, several coils each of the lower layer element coils 11 and the upper layer element coils 12 are arranged in the rotating direction for each of the U (X), V (Y), and W (Z) phases. In the example shown in FIG. 1, three coils each of the lower and upper layer element coils 11, 12 are arranged in the circumferential direction for each phase to provide the lower windings 101-106 and the upper winding 201-206 of the rotating direction. Therefore, in the embodiment shown in FIG. 1, two coils each of the U, V, and W phases, which are wound as concentrated windings, are disposed circumferentially. The lower layer rotating direction windings 101-106 are displaced from the corresponding upper layer rotating direction windings 201-206 by one tooth member or one slot for each phase.

Then, first and second U-phase rotating direction windings 301, 304 are formed by the U-phase lower layer rotating direction windings 101, 104 and the U-phase upper layer rotating direction windings 201, 204. First and second V-phase rotating direction windings 302, 305 are formed by the V-phase lower layer rotating direction windings 102, 105 and the V-phase upper layer rotating direction windings 202, 205. First and second W-phase rotating direction windings 303, 306 are formed by the W-phase lower layer rotating direction windings 103, 106 and the W-phase upper layer rotating direction windings 203, 206. As shown in FIG. 3, a Y-connection is formed about a neutral point 30 by the U-phase lower layer rotating direction windings 101, 104, the V-phase lower layer rotating direction windings 102, 105, and the W-phase lower layer rotating direction windings 103, 106. The U-phase upper layer rotating direction windings 201, 204, the V-phase upper layer rotating direction windings 202, 205, and the W-phase upper layer rotating direction windings 203, 206 are serially connected to the lower windings of each phase 101-106, respectively. Input terminals for each phase U2, V2, W2 are connected to the ends of the lower rotating direction windings101-106 so that the windings can be switched between high speed windings and low speed windings. The high speed windings receive current from the input terminals U2, V2, and W2, so that the current is supplied only to the lower windings of each phase 101-106. When switched to the low speed windings, the windings receive current from the input terminals U, V, and W, so that the current is supplied to both lower and upper layer windings of each phase 101-106, 201-206.

In the synchronous motor 100 of this embodiment, assuming that N_{cont} represents the number of element coils of each layer for each phase 11, 12 provided continuously in a circumferential direction, Nₛₗₒₜ represents the number of slots S1-S18, Nₚₒₗₑ represents the number of poles of the rotor 20, and Nₚₕₐₛₑ represents the number of applied phases of electric current, Nₛₗₒₜ±Nₚₒₗₑ=2n (n=1, 2, . . . integer) and Nₛₗₒₜ=A/(A−1)·Nₚₒₗₑ (note that A=Nₚₕₐₛₑ·N_{cont}) are satisfied. The element coils 11, 12 provided continuously for N_{cont} times are wound in m layers (m>1 and integer) and displaced from each other between adjacent layers by one slot in the rotating direction.

In the embodiment described above with reference to FIG. 1, N_{cont}=3, Nₛₗₒₜ=18, Nₚₒₗₑ−16, Nₚₕₐₛₑ=3, so that Nₛₗₒₜ+Nₚₒₗₑ=18+16=32, Nₛₗₒₜ−Nₚₒₗₑ=18−16=2. Therefore, A=Nₚₕₐₛₑ·N_{cont}=3·3=9, A/(A−1)·Nₚₒₗₑ=9/(9−1)·16=18=Nₛₗₒₜ, which satisfies the above requirements. Note that the number of layers m=2.

Also, in the structure of the synchronous motor of this embodiment, when the number of element coils provided continuously is N_{cont}, and the number of layers of the element coils m=2k (k is a natural number), the element coils are wound around [N_{cont}−(2k−1)] tooth members as concentrated windings, in the center part of the rotating direction winding for one phase, and wound around (2k−1) tooth members externally from the center of the rotating direction winding. The number of the element coils is larger as they become closer to the center of the rotating direction winding, and is smaller as they become farther from the center of the rotating direction winding. When m=2k−1 (k is a natural number), the element coils are wound around [N_{cont}−2(k−1)] tooth members as concentrated windings, in the center part of the rotating direction winding for one phase, and wound around 2(k−1) tooth members externally from the center of the winding of the rotating angle. The number of the element coils is larger closer to the center of the rotating direction winding and is smaller as farther from the center of the rotating direction winding.

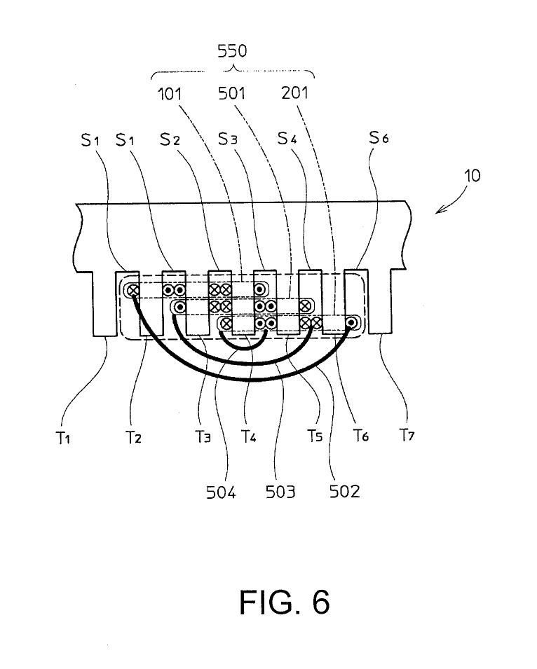

In this embodiment, N_{cont}=3, m=2, so that k=1, (2k−1)=1, [N_{cont}−(2k−1)]=2. Namely, the element coils are wound around the central two tooth members as concentrated windings and wound around one tooth member on both sides of the center of the rotating direction winding. As shown in FIG. 6 which will be described later, when N_{cont} is 3 and the number of layers m=3, then k=2, 2(k−1)=2 [N_{cont}−2(k−1)]=1. In this case, the element coils are wound around the central one tooth member as concentrated windings and wound around two tooth members each on both sides of the center of the rotating direction winding.

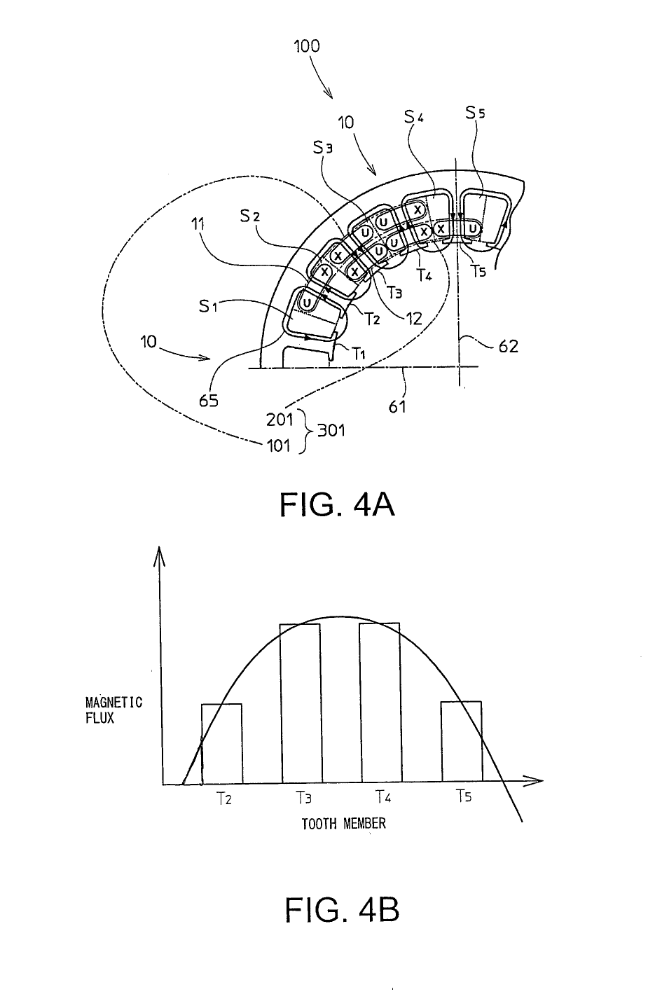

Operation of the synchronous motor 100 composed as described above will be described with reference to FIG. 4A and FIG. 4B. As shown in FIG. 4A, the lower U-phase rotating direction winding 101 and the upper U-phase rotating direction winding 201 are displaced from each other by 1 slot or 1 tooth member. Therefore, at the third and fourth tooth members T3, T4 located in the center of the first U-phase rotating direction winding 301, the upper and lower U-phase element coils 11, 12 are wound around the tooth members T3, T4. The second and fifth tooth members T2, T5 located circumferentially apart from the center of the first U-phase rotating direction winding 301 are wound by only the lower U-phase element coil 11 and the upper U-phase element coil 12, respectively. Therefore, when the current is fed to the first U-phase rotating direction winding 301, the intensity of the magnetic flux generated by the current indicated by a line 65 is higher in the vicinity of the third and fourth tooth members T3, T4 near the center of the first U-phase rotating direction winding 301, and is lower at the second and fifth tooth members T2, T5 located circumferentially apart from the center of the first U-phase rotating direction winding 301. As a result, a generally sine wave shaped magnetic flux is provided circumferentially in the first U-phase rotating direction winding 301. Thus, the torque ripples can be reduced effectively even in the concentrated winding structure according to this embodiment.

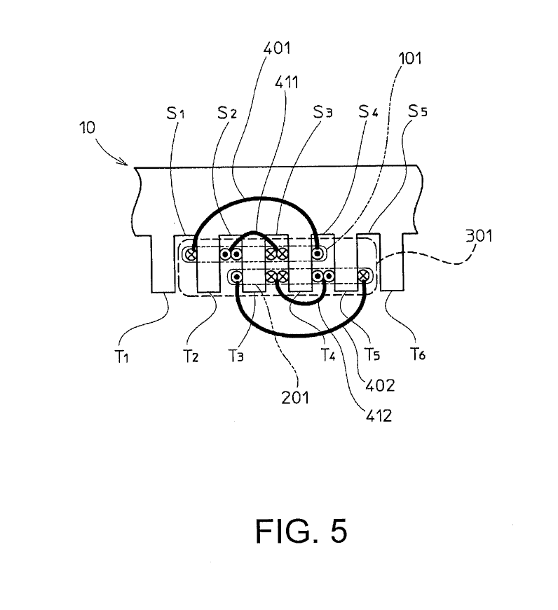

Referring to FIG. 5, another embodiment of the present invention will be described. The same reference characters are given to similar parts of the embodiment as described above with reference to FIGS. 1-4, and the description thereof will not be repeated. In contrast to the element coils 11, 12 wound around the tooth members T1-T18, respectively, in the embodiment described above with reference to FIG. 1, the element coils of this embodiment are wound by skipping over several slots. As shown in FIG. 5, the winding of the lower U-phase rotating direction winding 101 is composed of a first winding 401 wound between the first and fourth slots S1, S4, and a second winding 411 wound between the second and third slots S2, S3. As shown in FIG. 5, the first winding 401 runs into the stator 10 from the first slot S1 and goes out of the stator 10 from the fourth slot S4. Note that x marks in circles indicate that the winding runs through the drawing from the front side to the back side of the paper, and dots in circles indicate that the winding runs through the drawing from the back side to the front side of the paper. Also note that FIG. 5 is a schematic view of slots and tooth members arranged on the inner surface of the stator 10 in the circumferential direction when shown in a linearly extended manner. The second winding 411 runs into the stator 10 from the third slot S3 and goes out of the stator 10 from the second slot S2. The winding directions of the first and second windings 401, 411 are opposite to each other.

The upper U-phase rotating direction winding 201 is composed of a third winding 402 wound between the second and fifth slots S2, S5, and a fourth winding 412 wound between the third and fourth slots S3, S4. The third winding 402 runs into the stator 10 from the fifth slot S5 and goes out of the stator 10 from the second slot S2. The fourth winding 412 runs into the stator 10 from the third slot S3 and goes out of the stator 10 from the adjacent fourth slot S4. The winding directions of the third and fourth windings 402, 412 are opposite to each other. The lower and upper U-phase rotating direction windings 101, 201 are displaced from each other by one slot in the circumferential direction.

In this embodiment, the rotating direction windings are wound differently from the embodiment described with reference to FIG. 1, but the number of element coils around the third and fourth tooth members T3, T4 is larger than that around the first and fifth tooth members T1, T5 located on both ends of the windings. As a result, a generally sine wave shaped distribution of the magnetic flux is provided, as shown in FIG. 4B, when current is made to flow through the stator 10 . Similarly to the embodiment described above with reference to FIG. 1, the torque ripples can be reduced effectively even in the concentrated winding structure.

Referring to FIG. 6, another embodiment of the present invention will be described. The same reference characters are given to similar parts of the embodiment as described above with reference to FIGS. 1-5 and the description thereof will not be repeated. The rotating direction windings of this embodiment are provided in three layers along the length of the slots, with the windings provided between different layers of the rotating direction windings for each phase.

As shown in FIG. 6, this embodiment includes the lower U-phase rotating direction winding 101, the upper U-phase rotating direction winding 201, and a middle U-phase rotating direction winding 501. A first U-phase rotating direction winding 550 is formed by the lower, upper, and middle U-phase rotating direction windings 101, 201, 501. The rotating direction windings 101, 201, 501 are displaced from each other by one slot from the lower to middle and upper layers. A fifth winding 502 runs into the stator 10 from the first slot S1 and goes out of the stator 10 from the sixth slot S6. A sixth winding 503 runs into the stator 10 from the fifth slot S5 and goes out of the stator 10 from the second slot S2. A seventh winding 504 runs into the stator 10 from the third slot S3 and goes out of the stator 10 from the adjacent fourth slot S4.

As shown in FIG. 6, five coils are provided in each of the third and fourth slots, S3, S4, located on both sides of the fourth tooth member T4 in the center of the first U-phase rotating direction winding 550, on both sides of which three coils are provided in each of the second and fifth slots S2, S5, and one coil is provided in each of the first and sixth slots S1, S6, located on both ends of the winding. As such, the number of coils of the first U-phase rotating direction winding 550 is larger as it becomes closer to the center of the first U-phase rotating direction winding 550, and is smaller as it approaches both ends of the first U-phase rotating direction winding 550. As a result, the distribution of the magnetic flux is generally in the shape of a sine wave, as shown in FIG. 4B, when current is made to flow through the stator 10 . Similarly to the embodiment described above with reference to FIG. 1, the torque ripples can be reduced effectively even in the concentrated winding structure.

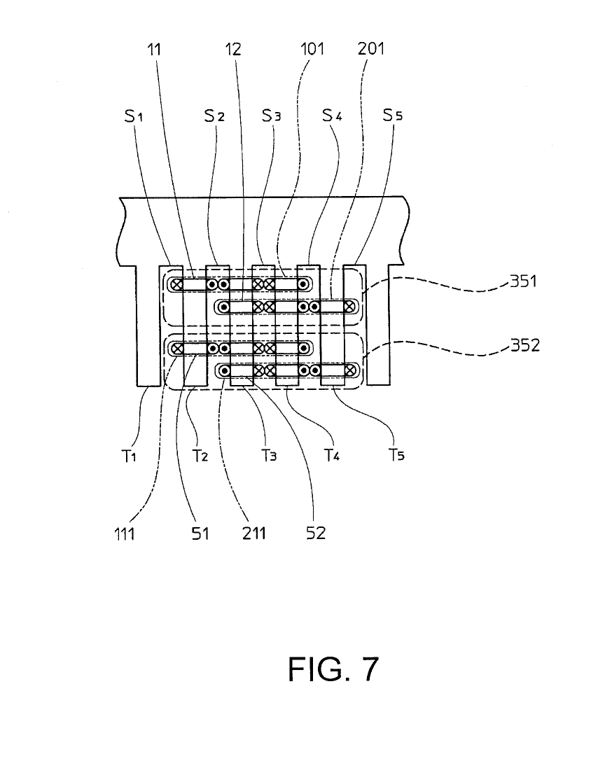

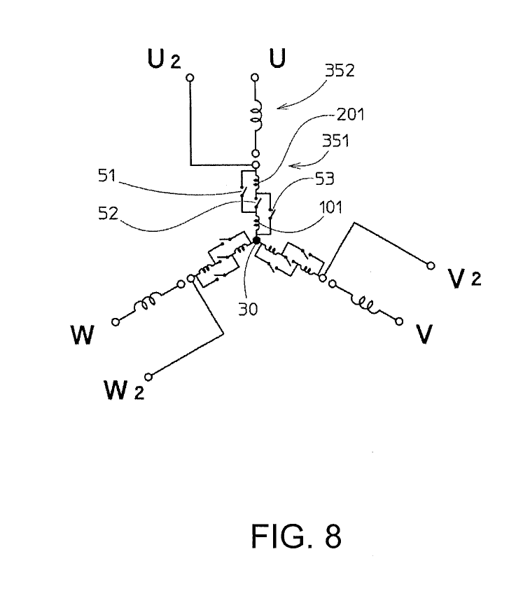

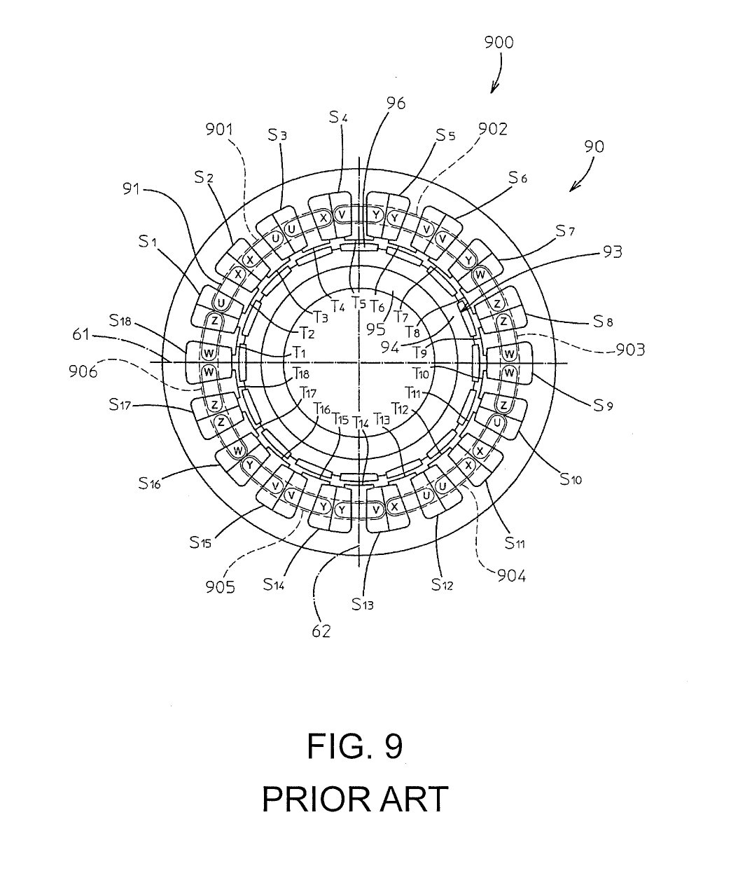

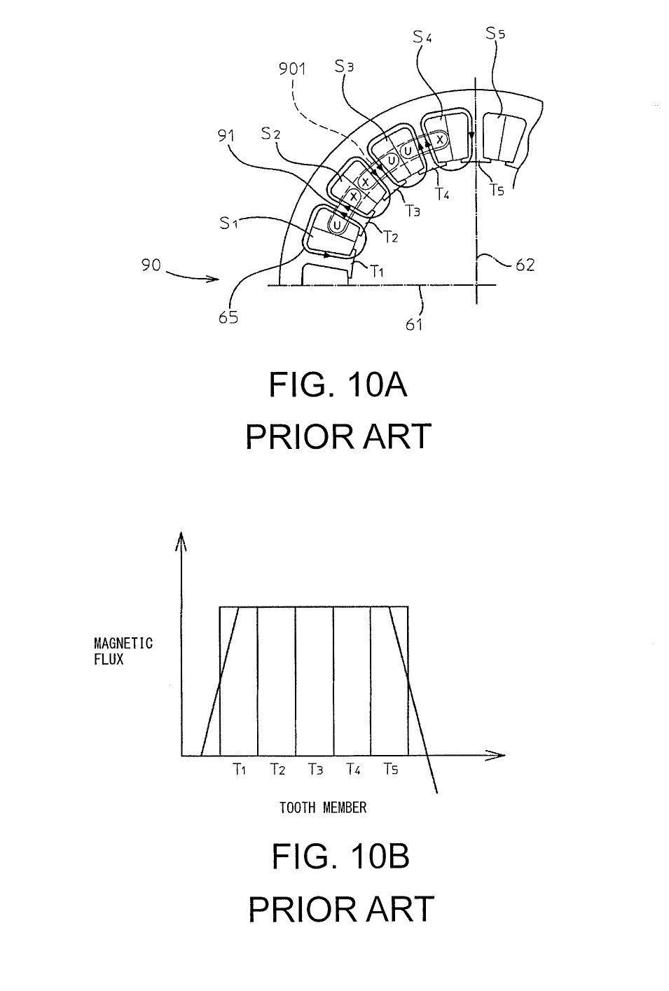

With reference to FIG. 7, another embodiment of the present invention will be described. As shown in FIG. 7, the stator 10 of the synchronous motor 100 of this embodiment includes two sets of the first U-phase rotating direction winding 301, described above with reference to FIG. 2, stacked along the extending direction of the slots or tooth members to form a lower first U-phase rotating direction winding 351 and an upper first U-phase rotating direction winding 352. As shown in FIG. 8, the lower first U-phase rotating direction winding 351 is connected to a neutral point to form a part of the Y-connection. A serial connection switch 51 is provided between the lower and upper U-phase rotating direction windings 101, 201, while parallel connection switches 51, 53 that allow parallel connection between the lower and upper U-phase rotating direction windings 101, 201 are provided. An input terminal U2 is connected on one end of the lower first U-phase rotating direction winding 351. The same configuration is provided for both V- and W-phases. The switches 51-53 are turned on/off by an external controller which is not shown.

When the synchronous motor 100 is operated at lower speeds by rendering the windings into low speed windings by the external controller which is not shown, the electric current is supplied from each terminal U, V, W to close the serial connection switch 52, whereby the lower and upper first U-phase windings 351, 352 are serially connected. In contrast, when the synchronous motor 100 is operated at higher speeds by rendering the windings into high speed windings by the external controller which is not shown, the electric current is supplied from each input terminal U2, V2, W2 to open the serial connection switch 52 and close the parallel connection switches 51, 53, whereby the lower and upper U-phase rotating direction windings 101, 201 are connected in parallel and a resistance of the windings is reduced. Consequently, a copper loss during the high speed operation can be reduced. Also, in this embodiment, the lower first U-phase rotating direction winding 351 is composed of the lower and upper U-phase rotating direction windings 101, 201 displaced from each other by one slot, so that a generally sine wave shaped distribution of the magnetic flux is provided circumferentially, as shown in FIG. 4B, even when the electric current is supplied only to the lower first U-phase winding 351 as a high speed winding. Therefore, the torque ripples can be reduced effectively during high speed operation in the concentrate winding structure.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1. A synchronous motor, comprising:
a rotor having a permanent magnet on a surface of or inside said rotor;
a stator made of a soft magnetic material and having a plurality of tooth members and a plurality of slots; and
a plurality of element coils wound around each of said tooth members as concentrated windings and arranged in multiple layers in an extending direction of said tooth members, wherein
a predetermined number of said element coils are arranged continuously for each phase in a circumferential direction to form a rotating direction winding for each phase, and
said rotating direction windings for each phase are displaced from each other between adjacent layers by one slot in the rotating direction.

2. The synchronous motor according to claim 1, wherein
if it is assumed that N_{cont} represents the number of said element coils provided continuously for each phase in a circumferential direction, Nₛₗₒₜ represents the number of said slots, Nₚₒₗₑ represents the number of poles of said rotor, and Nₚₕₐₛₑ represents the number of applied phases of electric current, then Nₛₗₒₜ±Nₚₒₗₑ=2n (n=1,2, . . . integer) and Nₛₗₒₜ=A/A−1)·Nₚₒₗₑ (note that A=Nₚₕₐₛₑ·N_{cont}) are satisfied, and
said element coils provided continuously for N_{cont} times are wound in m layers (m>1 and integer) and displaced from each other between adjacent layers by one slot in the rotating direction.

3. The synchronous motor according to claim 2, wherein
when the number of said element coils provided continuously is N_{cont}, and the number of layers, m, of said element coils is m=2k (k is a natural number), said element coils are wound around [N_{cont}−(2k−1)]tooth members as concentrated windings in the center part of said rotating direction winding for one phase, and wound around (2k−1) tooth members externally from the center of said rotating direction windings, such that the number of said element coils is larger as they become closer to the center of said rotating direction winding, and is smaller as they become farther from the center of said rotating direction winding, and
when m=2k−1 (k is a natural number), said element coils are wound around [N_{cont}−2(k−1)]tooth members as concentrated windings in the center part of said rotating direction winding for one phase, and wound around 2(k−1) tooth members externally from the center of said rotating direction windings, such that the number of said element coils is larger as they become closer to the center of said rotating direction winding, and is smaller as they become farther from the center of said rotating direction winding.

4. The synchronous motor according to claim 2, wherein
multiple sets of windings having an identical electrical characteristic are provided, and said multiple sets of windings are switched by winding switching means of an external controller so that said sets of windings are serially connected during low speed operation, and said sets of windings are connected in parallel during high speed operation.

5. The synchronous motor according to claim 3, wherein
multiple sets of windings having an identical electrical characteristic are provided, and said multiple sets of windings are switched by winding switching means of an external controller so that said sets of windings are serially connected during low speed operation, and said sets of windings are connected in parallel during high speed operation.

6. The synchronous motor according to claim 1, wherein winding directions of said adjacent tooth members are opposite to each other.

7. The synchronous motor according claim 2, wherein winding directions of said adjacent tooth members are opposite to each other.

8. The synchronous motor according claim 3, wherein winding directions of said adjacent tooth members are opposite to each other.

9. The synchronous motor according claim 4, wherein winding directions of said adjacent tooth members are opposite to each other.

10. The synchronous motor according claim 5, wherein winding directions of said adjacent tooth members are opposite to each other.
